(19) United States
(12) Patent Application Publication
(10) Pub. No.: US 2017/0351554 A1
(43) Pub. Date: Dec. 7, 2017

(54) METHOD AND SYSTEM FOR CLOUD SERVICE BASED ON REDISTRIBUTION OF PROCESSING POWER

(71) Applicants: NHN Entertainment Corporation, Seongnam-si (KR); NHN Studio629 Corporation, Seongnam-si (KR)

(72) Inventor: Chuljae LIM, Seongnam-si (KR)

(21) Appl. No.: 15/610,848

(22) Filed: Jun. 1, 2017

(30) Foreign Application Priority Data
Jun. 1, 2016 (KR) 10-2016-0068082
Jun. 1, 2016 (KR) 10-2016-0068167

(51) Int. Cl. G06F 9/50; H04L 29/08; G06F 9/46

(52) U.S. Cl. CPC G06F 9/5077; G06F 9/5072; G06F 9/46; H04L 67/1002

(57) ABSTRACT

A cloud service method and system based on redistribution of processing power includes registering electronic devices as operation processors and operation consumers through communication with the registered electronic devices over a network; separating, in response to an operation request from an operation consumer for processing power, the requested operation into a plurality of operations; requesting at least a portion of the registered operation processors to process the separated plurality of operations in a distributed manner in which more than one operation processor responds to the operation request; receiving and collecting the distributed processing results of the requested operation from the at least a portion of the registered operation processors; and providing the collected processing results to the operation consumer.

### CROSS-REFERENCE TO RELATED APPLICATIONS

This application claims priority from and the benefit of Korean Patent Application No. 10-2016-0068167, filed on Jun. 1, 2016 and Korean Patent Application No. 10-2016-0068082, filed on Jun. 1, 2016, which are hereby incorporated by reference for all purposes as if fully set forth herein.

### BACKGROUND OF THE INVENTION

### Field

This invention relates generally to a cloud service method and system, and more particularly, to a cloud service method and system based on redistribution of computer processing power.

### Description of the Background

A cloud service refers to technology capable of storing software and data in an external cloud server connected to the Internet and, if the Internet is connected, using the stored software or data without restriction on a time and a location. For example, Korean Patent Publication No. 10-2014-0036889 discloses a cloud service method and a terminal.

The cloud service may be classified into an Infrastructure as a Service (IaaS), a Platform as a Service (PaaS), Software as a Service (SaaS), etc., based on a service type. The IaaS is a model that generates a server, a storage, and a network in a virtualization environment and enables a user to use an infrastructure resource if necessary. The SaaS is also referred to on-demand software and is a software transfer model in which software and related data are hosted to a center and a user is connected through a client such as a web browser and the like. Also, the PaaS, as a scheme expanded from the concept of the SaaS to a development platform, is a model that may easily borrow and use necessary development elements without a need to construct a separate development platform.

A conventional cloud service may provide a service in which users may use infrastructure such as a server, a storage, a network, etc., constructed on the provider side of the cloud service, for a service such as software, related data, etc., a development platform, and the like.

Meanwhile, processing power equal to a super computer in previous times has been currently used by each home or individual, and even a mobile device has a computing capability of gigahertz (GHz). Thus, a large number of electronic devices used by homes and individuals may have relatively large surplus power.

### SUMMARY

Applicants have recognized that increasing demand for processing power may be met by the surplus processing power available in modern electronic devices. Methods and systems constructed according to the principles of the invention provide technological improvements enabling a computer network used as a cloud service to provide increased and more robust processing power to consumers by redistribution of processing power, e.g., by using surplus processing power from electronic devices in homes and portable devices carried by individuals.

Methods and systems constructed according to the principles of the invention also provide a cloud service that can incentivize efficient use of processing power by an automated system that obtains remuneration from consumers in need of processing power operations (“operation consumers”), and provides rewards to consumers or owners of surplus processing power (“operation processors”) who provide processing power for operation processing to operation consumers.

Additional features of the invention will be set forth in the description which follows, and in part will be apparent from the description, or may be learned by practice of the invention.

According to one aspect of the invention, a cloud service method for operating a cloud server includes registering electronic devices as operation processors and operation consumers through communication with the registered electronic devices over a network; separating, in response to an operation request from an operation consumer for processing power, the requested operation into a plurality of operations; requesting at least a portion of the registered operation processors to process the separated plurality of operations in a distributed manner in which more than one operation processor responds to the operation request; receiving and collecting the distributed processing results of the requested operation from the at least a portion of the registered operation processors; and providing the collected processing results to the operation consumer.

The method may further include the step of managing processing power that is available from at least some of the registered operation processors.

An application associated with the cloud service may be installed and executed on at least some of the registered electronic devices, and the step of managing of processing power may further include receiving device information and setting information provided from at least some of the registered electronic devices under control of the application, and determining processing power that is available from the at least some of the registered operation processors based on the received device information and setting information.

The device information may further include hardware information about the registered electronic devices, and the setting information may further include at least one of time information set by a user of the registered electronic devices and time information set by the application installed and executed on the registered electronic devices.

The step of requesting at least a portion of the registered operation processors to process the separated plurality of operations in a distributed manner may include selecting the at least a portion of the registered operation processors to process the plurality of operations based on processing power that is required for each of the plurality of operations and processing power that is available from the registered operation processors, and requesting the selected at least a portion of the registered operation processors to process one of the plurality of operations.

The method may further include the step of managing remuneration to be provided by the operation consumer in response to providing the processing results to the operation consumer, and managing a reward to provide to each of the registered operation processors providing the processing results to the operation consumer.

The step of managing of the reward may include determining the reward based upon an amount of processing power provided by the registered operation processors providing the processing results to the operation consumer and accumulatively managing the determined reward for the registered operation processors based upon the amount of processing provided by the registered operation processors.

The step of providing remuneration to the operation consumer may include providing remuneration from rewards that have been provided to the operation consumer, when the operation consumer was acting as one of the registered operation processors.

The method may further include the step of providing information about the reward to a service server associated with the cloud server, wherein the service server may be configured to perform either one of i) discount a service usage fee of a service for the registered operation processors based on the reward information and ii) to provide the service for free for the registered operation processors.

According to another aspect of the invention, a non-transitory computer-readable storage medium stores instructions that, when executed by a processor, cause the processor to perform a cloud service method for operating a cloud server that includes: registering electronic devices as operation processors and operation consumers through communication with the registered electronic devices over a network; separating, in response to an operation request from the an operation consumer for processing power, the requested operation into a plurality of operations; requesting at least a portion of the registered operation processors to process the plurality of operations in a distributed manner in which more than one operation processors respond to the operation request; receiving and collecting the distributed processing results of the requested operations from the at least a portion of the registered operation processors; and providing the collected processing results to the operation consumer.

According to yet another aspect of the invention, a cloud service system includes a cloud server having at least one processor configured to execute computer-readable instructions. The at least one processor is configured to register electronic devices as operation processors and operation consumers through communication with the registered electronic devices over a network; to separate, in response to an operation request from the an operation consumer for processing power, the requested operation into a plurality of operations; to request at least a portion of the registered operation processors to process the plurality of operations in a distributed manner in which more than one operation processors respond to the operation request; to receive and collect the distributed processing results of the requested operations from the at least a portion of the registered operation processors; and to provide the collected processing results to the operation consumer.

The at least one processor may be configured to manage processing power that is available from at least some of the registered operation processors.

An application associated with the cloud service may be installed and executed on at least some of the registered electronic devices, and to manage processing power, the at least one processor may be configured to receive device information and setting information provided from at least some of the registered electronic devices under control of the application, and to determine processing power that is available from the at least some of the registered operation processors based on the received device information and setting information.

The device information may further include hardware information about the registered electronic devices, and the setting information may further include at least one of time information set by a user of the registered electronic devices and time information set by the application installed and executed on the registered electronic devices.

For the at least one processor to request at least a portion of the registered operation processors to process the separated plurality of operations in a distributed manner, the at least one processor may be configured to select the at least a portion of the registered operation processors to process the plurality of operations based on processing power that is required for each of the plurality of operations and a processing power that is available from the registered operation processors, and to request the selected at least a portion of the registered operation processors to process one of the plurality of operations.

The at least one processor may be configured to manage remuneration to be provided by the operation consumer in response to providing the processing results to the operation consumer, and to manage a reward to provide to each of the registered operation processors providing the processing results to the operation consumer.

To manage the reward, the at least one processor may be configured to determine the reward based upon an amount of processing power provided by the registered operation processors and to accumulatively manage the determined reward for the registered operation processors based upon the amount of processing power provided by the registered operation processors.

The at least one processor may be configured to provide the remuneration to the operation consumer, from rewards that have been provided to the operation consumer, when the operation consumer was acting as one of the registered operation processors.

The at least one processor may be configured to provide information about the reward to a service server associated with the cloud server, wherein the service server may be configured to perform either one of i) discount a service usage fee of a service for the registered operation processors based on the reward information and ii) to provide the service for free for the registered operation processors.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an exemplary network environment in which cloud system and methods according to the principles of the invention may be employed.

FIG. 2 illustrates an exemplary electronic device and a server that may be employed in cloud systems and methods according to the principles of the invention.

FIG. 3 illustrates an exemplary environment for providing processing power through a cloud service according to the principles of the invention.

FIG. 4 illustrates exemplary components that may be included in a processor of a cloud system server constructed according to the principles of the invention.

FIG. 5 is a flowchart illustrating an exemplary method performed at a cloud system server constructed according to the principles of the invention.

FIG. 6 illustrates another example of components that may be included in a processor of a cloud system server constructed according to the principles of the invention.

FIG. 7 is a flowchart illustrating another exemplary method performed at a cloud system server according to the principles of the invention.

FIG. 8 illustrates an exemplary application package provided to an electronic device to configure a client according to the principles of the invention.

FIG. 9 illustrates an exemplary process for exchanging processing power and an incentive-based service according to the principles of the invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

Unless otherwise specified, the illustrated exemplary embodiments are to be understood as providing exemplary features of varying detail of various exemplary embodiments. Therefore, unless otherwise specified, the features, components, modules, regions, and/or aspects of the various illustrations may be otherwise combined, separated, interchanged, and/or rearranged without departing from the disclosed exemplary embodiments. When an exemplary embodiment may be implemented differently, a specific process order may be performed differently from the described order. For example, two consecutively described processes may be performed substantially at the same time or performed in an order opposite to the described order. Also, like reference numerals denote like elements.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing example embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

Hereinafter, exemplary embodiments are described in detail with reference to the accompanying drawings.

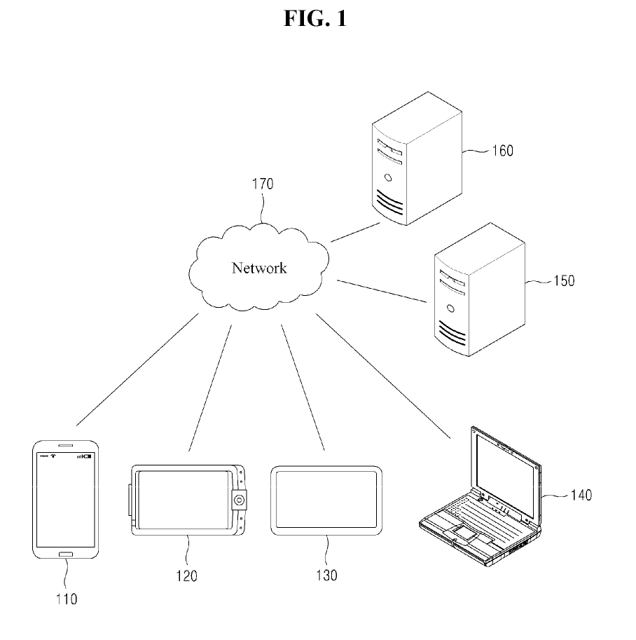

FIG. 1 illustrates an exemplary network environment in which cloud system and methods according to the principles of the invention may be employed. Referring to FIG. 1, the network environment includes a plurality of electronic devices 110, 120, 130, and 140, a plurality of servers 150 and 160, and a network 170. FIG. 1 is provided as an example only, and the number of electronic devices and the number of servers are not limited thereto.

Each of the plurality of electronic devices 110, 120, 130, and 140 may be a fixed terminal or a mobile terminal configured as a computer device. For example, the plurality of electronic devices 110, 120, 130, and 140 may be a smartphone, a mobile phone, navigation, a computer, a laptop computer, a digital broadcasting terminal, a personal digital assistant (PDA), a portable multimedia player (PMP), a tablet personal computer (PC), and the like. For example, although FIG. 1 illustrates a smartphone as an example of the electronic device 110, it is provided as an example only. In the exemplary embodiments, the electronic device 110 may indicate one of the various devices capable of communicating with other electronic devices 120, 130, and/or 140, and/or the servers 150 and/or 160 over the network 170 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, and a broadcasting network, which may be included in the network 170. For example, the network 170 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 170 may include at least one of network topologies that include a bus network, a star network, a ring network, a mesh network, a star-bus network, a tree or hierarchical network, and the like. However, the exemplary embodiments are not limited to these examples.

Each of the servers 150 and 160 may be configured as one or more computers that provide instructions, codes, files, contents, services, and the like, through communication with the plurality of electronic devices 110, 120, 130, and/or 140 over the network 170.

For example, the server 160 may be a file distribution system configured to distribute an installation file of an application for a messenger function or an application for playback of digital contents for the plurality of electronic devices 110, 120, 130, and/or 140. In this case, the server 150 may be a cloud service system configured to provide a cloud service to clients on which the application is installed. For example, a user of the electronic device 110 may connect to the server 150 through the network 170 using the application installed on the electronic device 110, and may utilize the cloud service provided from the server 150. In this case, the server 150 may transmit the requested cloud service to the electronic device 110.

As another example, the server 150 may be a cloud service server configured to provide a cloud service to the plurality of electronic devices 110, 120, 130, and/or 140, and the server 160 may be a service server configured to provide a service, for example, a game service, to the plurality of electronic devices 110, 120, 130, and/or 140 in conjunction with the cloud service server.

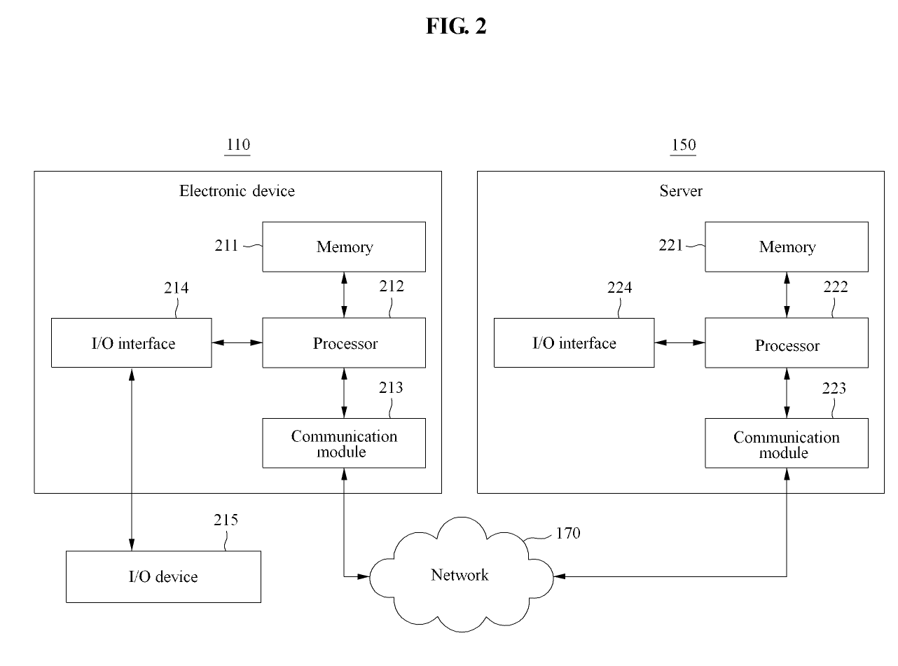

FIG. 2 illustrates an exemplary electronic device and a server that may be employed in cloud systems and methods according to the principles of the invention. FIG. 2 illustrates a configuration of the electronic device 110 as an example for a single electronic device and illustrates a configuration of the server 150 as an example for a single server. The same or similar components may be applicable to other electronic devices 120, 130, and/or 140, or the server 160, and also to other electronic devices or other servers.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memories 211, 221 may include a permanent mass storage device, such as random access memory (RAM), read only memory (ROM), a disk drive, etc., as a computer-readable storage medium. Here, ROM and the permanent mass storage device may be included as a separate permanent storage device, distinct from the memories 211, 221. Also, an OS and at least one program code, for example, a code for a browser installed and executed on the electronic device 110, an application installed on the electronic device 110 to provide a specific service, etc., may be stored in the memories 211, 221. Such software components may be loaded from another computer-readable storage medium, distinct from the memories 211, 221, using a drive mechanism known in the art. The other computer-readable storage medium may include, for example, a floppy drive, a disk, a tape, a DVD/CD-ROM drive, a memory card, etc. According to other exemplary embodiments, software components may be loaded to the memories 211, 221 through the communication modules 213, 223, instead of, or in addition to, the computer-readable storage medium. For example, at least one program may be loaded to the memories 211, 221 based on a program, for example, the application, installed by files provided over the network 170 from developers, or a file distribution system, for example, the server 160, which provides an installation file of the application.

The processors 212, 222 may be configured to process computer-readable instructions, for example, the aforementioned at least one program code, of a computer program by performing basic operations, logic operations, and I/O operations. The computer-readable instructions may be provided from the memories 211, 221 and/or the communication modules 213, 223 to the processors 212, 222. For example, the processors 212, 222 may be configured to execute received instructions in response to the program code stored in the storage device, such as the memories 211, 222.

The communication modules 213, 223 may provide a function for communication between the electronic device 110 and the server 150 over the network 170, and may provide a function for communication with another electronic device, for example, the electronic device 120 or another server, for example, the server 160. For example, the processor 212 of the electronic device 110 may transfer a request, for example, a request for a video call service, created based on a program code stored in the storage device such as the memory 211, to the server 150 over the network 170 under control of the communication module 213. Alternatively, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, etc., of the server 150 received through the communication module 213 may be transferred to the processor 212 or the memory 211, and content, a file, etc., may be stored in a storage medium further includable in the electronic device 110.

The I/O interfaces 214, 224 may be one or more devices used to interface with an I/O device 215. For example, an input device may include a keyboard, a mouse, etc., and an output device may include a device, such as a display for displaying a communication session of an application. As another example, the I/O interface 214 may be a device for interface with an apparatus in which an input function and an output function are integrated into a single function, such as a touch screen. In detail, when processing instructions of the computer program loaded to the memory 211, the processor 212 of the electronic device 110 may display a service screen configured using data provided from the server 150 or the electronic device 120, or may display content on a display through the I/O interface 214.

According to other exemplary embodiments, the electronic device 110 and the server 150 may include a greater or lesser number of components than the number of components shown in FIG. 2. However, there clearly is no need to illustrate many components known in the related art. For example, the electronic device 110 may include at least a portion of the I/O device 215, or may further include other components, for example, a transceiver, a global positioning system (GPS) module, a camera, a variety of sensors, a database, and the like. In detail, if the electronic device 110 is a smartphone, the electronic device 110 may be configured to further include a variety of components, for example, an accelerometer sensor, a gyro sensor, a camera, various physical buttons, a button using a touch panel, an I/O port, a vibrator for vibration, etc., which are generally included in the smartphone.

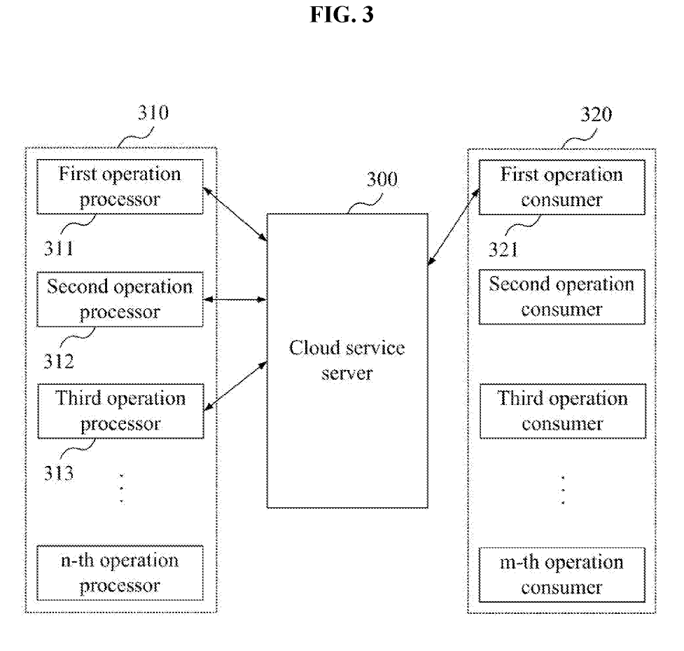

FIG. 3 illustrates an exemplary environment for providing processing power through a cloud service according to the principles of the invention. More specifically, FIG. 3 illustrates a cloud service server 300, a plurality of operation processors 310, and a plurality of operation consumers 320. As used herein, consumers requesting or in need of processing power operations are referred to as “operation consumers”, and consumers or owners of surplus processing power who have devices that may supply processing power to operation consumers are referred to as “operation processors.”

The cloud service server 300 may be configured as the server 150 described in FIGS. 1 and 2, and the plurality of operation processors 310 may correspond to electronic devices registered to the cloud service server 300 among electronic devices, for example, a PC, a smartphone, etc., distributed to homes or individuals. For example, a first operation processor 311 may be configured as the electronic device 110 of FIG. 2. Each of the plurality of operation consumers 320 may be configured in the same form as the server 150 and may also be configured in the same form as the electronic device 110. Further, each of the plurality of operation consumers 320 may simultaneously perform the functionality as an operation consumer and an operation processor. For example, a first operation consumer 321 and a third operation processor 313 may be configured on a single electronic device, for example, the electronic device 110.

The cloud service server 300 may receive an operation request from a specific operation consumer, for example, the first operation consumer 321, which desires processing of a predetermined operation. Also, the cloud service server 300 may select operation processors, for example, the first operation processor 311, a second operation processor 312, and the third operation processor 313, from among the plurality of operation processors 310, and may match the specific operation consumer and the selected operation processors, so that the selected operation processor may process the requested operation in a distributed manner, such as to receive processing from multiple operation processors.

For example, the cloud service server 300 may assign a value to surplus processing power and may construct and use the robust real-time processing power by processing, in a distributed manner, the operation request from the specific operation consumer using the processing power of at least a portion of the registered plurality of operation processors 310.

To construct the processing power as above, the cloud service server 300 may provide a technological and/or monetary reward or benefit for processing power that is provided from the plurality of operation processors 310. For example, the cloud service server 300 may exchange surplus processing power and power consumed for operation processing with a service by providing a specific service, for example, a game, for free or by discounting a fee with respect to an operation processor that provides the processing power. As another example, the reward may be provided to an operation processor in a form of cash, cyber money, and the like. As another example, the reward provided to an operation processor may be accumulated in the cloud service server 300 in association with the corresponding operation processor, and the operation processor, as an operation consumer, may request the cloud service server 300 for processing a desired operation using accumulated rewards. In this case, as described above, a single client of the cloud service may be the operation processor and the operation consumer at the same time.

As described above, by providing a reward according to processing power provided or exchanged with a service, it is possible to provide enhanced real-time processing power using the surplus processing power of the client.

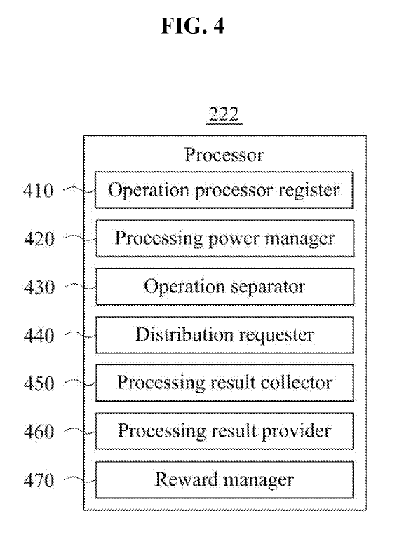

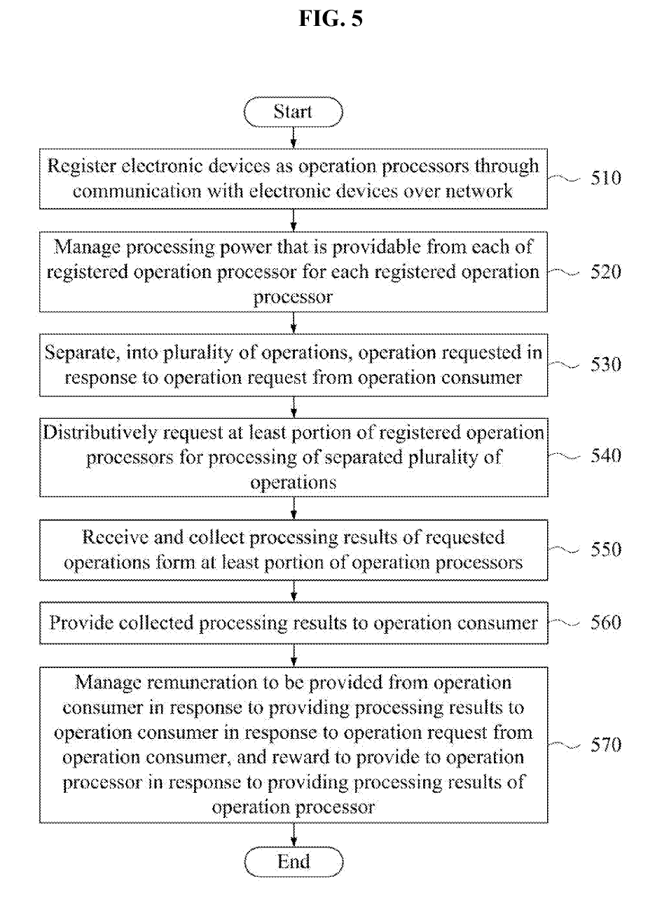

FIG. 4 illustrates exemplary components that may be included in a processor of a cloud system server constructed according to the principles of the invention, and FIG. 5 is a flowchart illustrating an exemplary method performed at a cloud system server constructed according to the principles of the invention.

The server 150 may configure a client service server according to exemplary embodiments. Referring to FIG. 4, the processor 222 included in the server 150 may include, as components, an operation processor register 410, a processing power manager 420, an operation separator 430, a distribution requester 440, a processing result collector 450, a processing result provider 460, and a reward manager 470. The processor 222 and the components of the processor 222 may perform operations 510 through 570 included in a cloud service method of FIG. 5. Here, the processor 222 and the components of the processor 222 may be configured to execute instructions corresponding to a code of at least one program or a code of the OS included in the memory 221. Here, the components of the processor 222 may be representations of different functions of the processor 222 performed by the processor 222 in response to a control instruction that is provided from the program code stored on the server 150. Here, the processor 222 may read a necessary control instruction from the memory 221 to which instructions associated with control of the server 150 are loaded and may control the server 150 to perform operations 510 through 570 in response to the read control instruction.

In operation 510, the operation processor register 410 may register electronic devices as operation processors through communication with the electronic devices over a network. For example, an application associated with a cloud service may be installed and executed on each of the electronic devices of the registered operation processors, and clients for the cloud service may be configured on the electronic devices. Here, the electronic devices corresponding to the clients may be registered on the server 150 as the operation processors. For example, the operation processor register 410 may control the server 150 to receive, from a corresponding electronic device, at least a portion of information, and to store the received information on a database for managing an operation processor with an identifier as the operation processor of the electronic device. The information may be, for example, electronic device information and user information, such as an identifier of the electronic device, an identifier of a user of the electronic device, an identifier of a client configured on the electronic device, and the like.

In operation 520, the processing power manager 420 may manage processing power that is available from each of the registered operation processors for each registered operation processor. For example, the processing power manager 420 may control the server 150 to receive information transmitted from an electronic device under control of an application executed on the electronic device, and may determine the processing power of the electronic device based on the received information. In detail, the processing power manager 420 may control the server 150 to receive device information and setting information of the electronic device from a client configured on the electronic device. Here, the device information may include hardware information of the electronic device. For example, the server 150 may receive hardware information, such as a type of a central processing unit (CPU), a clock rate, and the like, as the device information. Also, the setting information may include at least one of time information set by a user of the electronic device and time information set by the application installed and executed on the electronic device. The time information may be information about a time at which the electronic device is capable of providing the processing power. For example, if the user is using the electronic device, it may be difficult to provide the processing power. Accordingly, the user may notify the server 150 about a time at which the user does not use the electronic device by setting the time. Also, the application executed on the electronic device may analyze an operation pattern of the electronic device, may automatically set a time at which surplus processing power remains, and may notify the server 150 about the set time. The processing power manager 420 may determine the available surplus processing power for each operation processor based on the device information and the setting information.

The surplus processing power may be determined to be different over time with respect to the same client. Thus, the processing power may be determined at predetermined periods or every time an operation request is received from an operation consumer. That is, operation 520 may be performed after operation 530.

In operation 530, the operation separator 430 may separate, into a plurality of operations, an operation requested in response to an operation request from the operation consumer. Various types of operations may be requested from operation consumers. For example, the operation consumers may request any type of operations requiring the processing power, such as a request for processing data for weather analysis at a weather center, a request for processing data at an institution, a request for processing a game simulation at a game server providing a game service, and the like. To this end, the server 150 may provide the operation consumers with a window through which the operation consumers may approach to request an operation. The aforementioned window may be provided to the operation consumers through a webpage form or a separate application installed on each of the devices of the operation consumers. Each of the operation consumers may request the server 150 for desired operation processing using an interface of the window provided from the server 150.

In this case, the operation separator 430 may analyze the requested operation and may separate the operation into a plurality of operations. For example, in response to a request for processing an operation that requires 100,000 simulation iterations, the operation separator 430 may separate the requested operation into 100,000 operations each processing a single simulation. Alternatively, when the requested operation includes various types of operations instead of iterative operations, the operation separator 430 may individually separate the plurality of operations included in the requested operation.

In operation 540, the distribution requester 440 may request at least a portion of the registered operation processors to process the separated plurality of operations in a distributed manner. For example, the distribution requester 440 may control the server 150 to select at least a portion of the operation processors for requesting processing of the plurality of operations based on processing power that is required for each of the plurality of operations and processing power that is available from each of the registered operation processors, and to request the selected at least a portion of the operation processors for processing of a corresponding operation.

As an example, it is assumed that an operation that requires 100,000 simulation iterations is separated into 100,000 operations each processing a single simulation and 500,000 operation processors are registered. In this case, the distribution requester 440 may process 100,000 operations in parallel by selecting 100,000 operation processors capable of providing processing power required for processing the 100,000 operations and by requesting the selected 100,000 operation processors for processing of the separated operations in a distributed manner.

In operation 550, the processing result collector 450 may receive and collect processing results of the requested operations from at least a portion of the registered operation processors. For example, the processing result collector 450 may control the server 150 to receive the processing results transmitted from the operation processors, and may generate final processing results by combining the received processing results.

Here, a result of a first operation included in the requested operation may be used as an input of a second operation included in the requested operation. For example, a result of a primary operation may be required as a parameter of a secondary operation. In this case, it is possible to request operation processors primarily selected for the primary operation for processing of the primary operation, to collect the results thereof, and to request operation processors secondarily selected for the secondary operation for processing of the secondary operation by including the collected results. That is, the final operation results may be acquired by iteratively performing operations 540 and 550 based on order of the requested operation.

In operation 560, the processing result provider 460 may provide the collected processing results to the operation consumer. For example, the processing result provider 460 may control the server 150 to transmit data including the collected processing results to a device of the operation consumer over the network, for example, the network 170 of FIG. 1. For example, the operation consumer requesting an operation for 100,000 simulations may receive processing results which are acquired by processing the results of each of the 100,000 operation processors.

In operation 570, the reward manager 470 may manage a remuneration to be provided from the operation consumer in response to providing the processing results to the operation consumer. The step of providing the processing results to the operation consumer is in response to the operation request from the operation consumer. The reward manager 470 may also manage a reward to be provided to the operation processor in response to providing the processing results of the operation processor. For example, a provider side of the cloud service may make revenue by receiving remuneration for operations from the operation consumers and may provide at least a portion of the revenues to the operation processors as a reward, thereby inducing participation of many users to provide further robust and increased processing power.

The reward may be provided in various types. For example, each of the operation processors may receive the reward by exchanging processing power with a service, a technological benefit, or in a form of cash, cyber money, and the like. For example, the reward may be determined based on a throughput of a corresponding operation processor. In detail, a relatively high reward may be provided to an operation processor that provides a relatively high throughput. Also, the provided reward may be accumulatively managed with respect to a corresponding operation processor based on the type of the provided reward. In this case, the operation processor may use the accumulated rewards as remuneration for using the processing power. That is, the server 150 may provide the remuneration from the operation consumer in response to providing the collected processing results to the operation consumer, from rewards that are previously provided to the operation consumer as an operation processor and accumulated thereof, so that the operation consumer may use a reward acquired through cloud operation processing as a remuneration for operation consumption. For example, it is assumed that reward of ‘1’ is provided to an operation processor providing the processing power for 1 minute through an electronic device having a CPU clock rate of 1 GHz. In this case, if the corresponding operation processor provides the processing power for 3 hours, rewards of ‘180’ may be accumulated for the corresponding operation processor and be managed at the server 150. As an operation consumer, the corresponding operation processor may use the processing power provided from the server 150 as much as the accumulated rewards of ‘180’. That is, the accumulated rewards of ‘180’ may be used as the remuneration for the processing power that is used by the corresponding operation processor, as the operation consumer.

Various types of rewards are further described below.

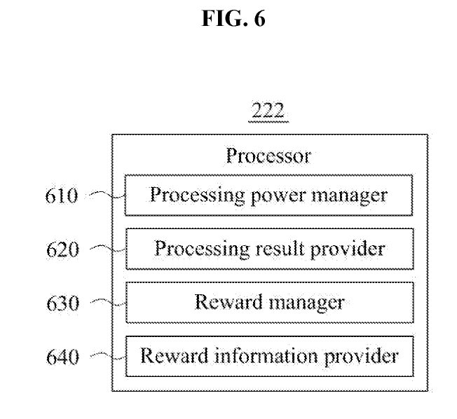

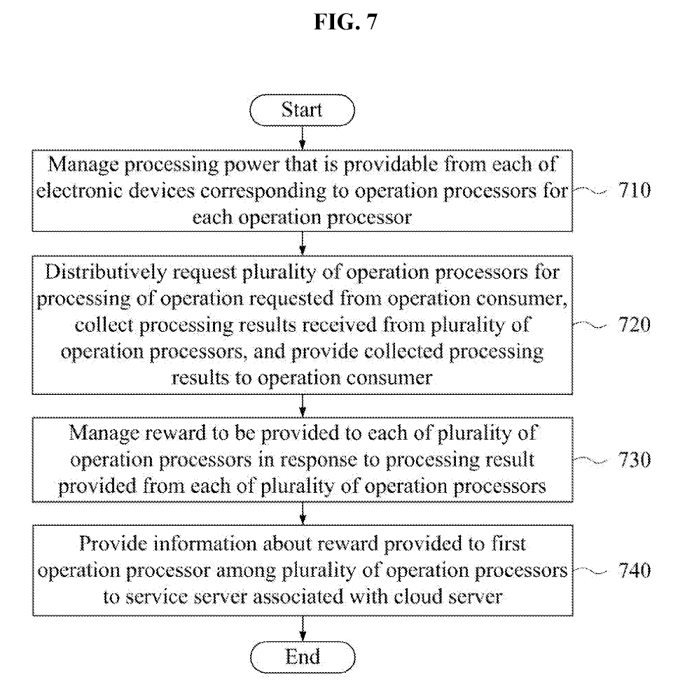

FIG. 6 illustrates another example of components that may be included in a processor of a cloud system server constructed according to the principles of the invention, and FIG. 7 is a flowchart illustrating another exemplary method performed at a cloud system server according to the principles of the invention.

Referring to FIG. 6, the processor 222 of the server 150 may include, as components, a processing power manager 610, a processing result provider 620, a reward manager 630, and a reward information provider 640. The processor 222 and the components of the processor 222 may perform operations 710 through 740 included in a cloud service method of FIG. 7. Here, the processor 222 and the components of the processor 222 may be configured to execute instructions according to a code of at least one program or a code of the OS included in the memory 221. Here, the components of the processor 222 may be representations of different functions of the processor 222 performed by the processor 222 in response to a control instruction provided from the program code stored on the server 150. Here, the processor 222 may read a necessary control instruction from the memory 221 to which instructions associated with control of the server 150 are loaded, and may control the server 150 to perform operations 710 through 740 in response to the read control instruction.

In operation 710, the processing power manager 610 may manage processing power that is available from each of the electronic devices corresponding to operation processors for each operation processor. Each of the operation processors may include a corresponding electronic device. The server 150 may register the electronic devices as the operation processors through communication with the electronic devices over a network. For example, an application associated with a cloud service may be installed and executed on each of the electronic devices of the registered operation processors, and clients for the cloud service may be correspond to the electronic devices. Here, the electronic devices configured on the clients may be registered to the server 150 as the operation processors.

In this case, the processing power manager 610 may control the server 150 to receive information transmitted from an electronic device under control of the application executed on the electronic device and may determine the processing power of the electronic device based on the received information. In detail, the processing power manager 620 may control the server 150 to receive device information and setting information of the electronic device from a client configured on the electronic device. Here, the device information may include hardware information of the electronic device. For example, the server 150 may receive hardware information, such as a type of a CPU, a clock rate, and the like, as the device information. Also, the setting information may include at least one of time information set by a user of the electronic device and time information set by the application installed and executed on the electronic device. The time information may be information about a time at which the electronic device is capable of providing the processing power. For example, if the user is using the electronic device, it may be difficult to provide the processing power. Accordingly, the user may notify the server 150 about a time during which the user does not use the electronic device by setting such time. Also, the application executed on the electronic device may analyze an operation pattern of the electronic device, may automatically set a time at which surplus processing power remains, and may notify the server 150 about the set time. The processing power manager 610 may determine the available surplus processing power for each operation processor based on the device information and the setting information.

In operation 720, the processing result provider 620 may request a plurality of operation processors for processing of an operation requested from an operation consumer in a distributed manner, may collect processing results received from the plurality of operation processors, and may provide the collected processing results to the operation consumer. A description related to requesting the plurality of operation processors for processing of the requested operation in a distributed manner, collecting the individual processing results, and providing the collected processing results to the operation consumer is described above with reference to FIGS. 4 and 5 and thus, further description here is unnecessary.

In operation 730, the reward manager 630 may manage a reward to be provided to each of the plurality of operation processors in response to the processing result provided from each of the plurality of operation processors. For example, the reward manager 630 may determine a reward for a first operation processor of the plurality of operation processors based on a throughput of the first operation processor and may accumulate and manage the determined reward with respect to the first operation processor. The reward management may be applied to any of operation processors that provide the processing power.

In operation 740, the reward information provider 640 may provide information about the reward provided to the first operation processor of the plurality of operation processors to a service server associated with the cloud server. For example, the reward information provider 640 may control the server 150 to transmit information about the reward provided to the first operation processor to the service server over the network 170.

Here, the reward information provider 640 may provide the quantity of accumulated rewards of the first operation processor to the service server. A user of an electronic device corresponding to the first operation processor may be a user of a service provided from the service server, and may receive a discount on a usage fee of the service provided from the service server or may utilize the service for free based on the quantity of accumulated rewards. That is, the service server may discount the service fee or may provide the service for free with respect to the first operation processor based on reward information received from the server 150. Accordingly, the processing power of the first operation processor and the service provided from the service server may be exchanged with each other.

Exemplary embodiments in which an operation processor is capable of requesting a cloud service system for operation processing as an operation consumer using a reward acquired as the operation processor are described with reference to FIGS. 4 and 5. Also, exemplary embodiments in which the operation processor receives a discount on a service use fee or utilizes a service for free using a reward acquired in response to providing the processing power are described above with reference to FIGS. 6 and 7. In addition, the reward may be provided to the operation processor in a form of cash or cyber money, or technological benefit.

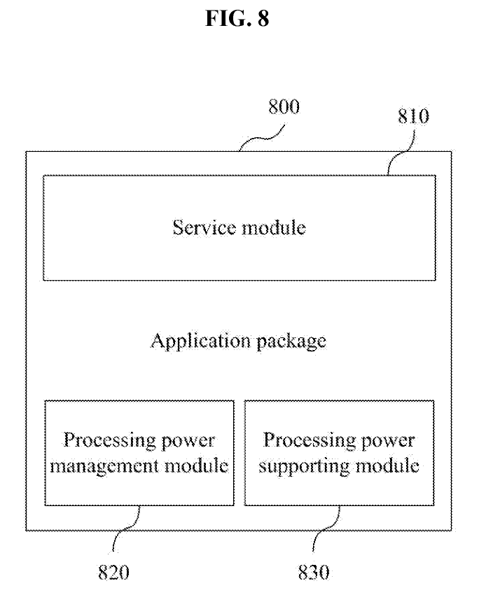

FIG. 8 illustrates an exemplary application package provided to an electronic device to configure a client according to the principles of the invention. FIG. 8 illustrates an exemplary application package 800 installed on an electronic device, for example, the electronic device 110 of FIG. 1. Referring to FIG. 8, the application package 800 includes a service module 810, a processing power management module 820, and a processing power supporting module 830.

The service module 810 may include a function of receiving a service, such as a game service, from a service server connected to a cloud service server. As described above, when rewards are accumulated in response to providing processing power from an operation processor corresponding to the electronic device, the operation processor may receive a discount on a usuage fee of the service provided from the service server or may use a paid service for free. The application package 800 may include the service module 810 to receive a plurality of services from a plurality of service servers. Here, the operation processor may select a service for using the accumulated rewards.

The processing power management module 820 may include a function of controlling the electronic device so that the client may manage information, for example, device information or setting information, about the processing power of the electronic device and may transmit the managed information to the cloud service server under control of the application. Based on the information provided through the processing power management module 820, the cloud service server may verify the operation processor that provides the processing power, a point in time at which the processing power is available, and the magnitude of processing power being provided.

The processing power supporting module 830 may include a function of controlling the electronic device so that the client may process an operation requested from the cloud service server. For example, the client may control the electronic device to recognize an operation to be processed by analyzing a message provided from the cloud service server and to process the recognized operation through the processing power supporting module 830. Also, the client may provide the processing results to the cloud service server in an appropriate form through the processing power supporting module 830. Here, the cloud service server may collect the processing results that are received from the operation processors corresponding to clients and may provide the collected processing results to an operation consumer.

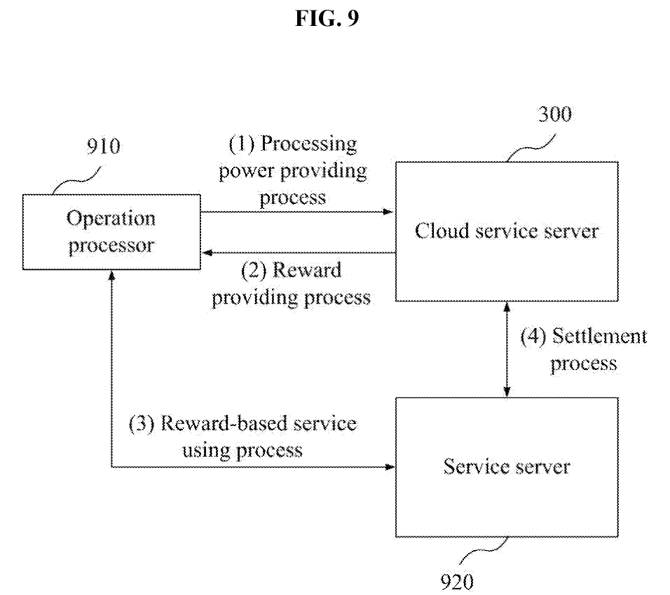

FIG. 9 illustrates an exemplary process for exchanging processing power and an incentive-based service according to the principles of the invention. As described above, the cloud service server 300 may separate an operation requested from an operation consumer into a plurality of operations, and may request at least a portion of the registered operation processors to process the separated plurality of operations in a distributed manner.

In FIG. 9, (1) Processing power providing process may be an example of a process in which an operation processor 910 provides processing power of the operation processor 910 by processing a requested operation and by transmitting a processing result thereof to the cloud service server 300.

In FIG. 9, (2) Reward providing process may be an example of a process in which the cloud service server 300 provides the operation processor 910 with a reward corresponding to a magnitude of the processing power provided from the operation processor 910. The magnitude of the processing power may be determined based on a throughput of the operation processor 910 and may also be determined based on a clock rate of a CPU of the operation processor 910 and a period in which the operation processor 910 provides the processing power.

In FIG. 9, (3) Reward-based service using process may be an example of a process in which the operation processor 910 uses a service provided from a service server 920 using the provided reward. For example, the reward may be cyber money or an item available at the service, and may be used to receive a discount for a service use fee or to use a paid service for free.

In FIG. 9, (4) Settlement process maybe an example of a process in which the cloud service server 300 and the service server 920 settle expenses about use of the reward of the operation processor 910.

The cloud service server 300 may provide rewards about various services to operation processors in conjunction with a plurality of service servers, thereby inducing the operation processors to further actively participate in providing processing power.

According to the principles of the invention, it is possible to provide robust and increased processing power to operation consumers using surplus processing power left after being used at electronic devices distributed to homes and individuals. Also, it is possible to incentivize sharing of processing power by receiving remuneration from operation consumers in response to processing operations requested from the operation consumers, and by providing rewards to operation processors that provide processing power for operation processing.

The elements described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over a network coupled with computer systems so that the software is stored and executed in a distributed fashion. In particular, the software and data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of this disclosure, or they may be well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A cloud service method for operating a cloud server, the method comprising:
registering electronic devices as operation processors and operation consumers through communication with the registered electronic devices over a network;
separating, in response to an operation request from an operation consumer for processing power, the requested operation into a plurality of operations;
requesting at least a portion of the registered operation processors to process the separated plurality of operations in a distributed manner in which more than one operation processor responds to the operation request;
receiving and collecting the distributed processing results of the requested operation from the at least a portion of the registered operation processors; and
providing the collected processing results to the operation consumer.

2. The method of claim 1, further comprising the step of:
managing processing power that is available from at least some of the registered operation processors.

3. The method of claim 2, wherein an application associated with the cloud service is installed and executed on at least some of the registered electronic devices, and
the step of managing of processing power further comprises receiving device information and setting information provided from at least some of the registered electronic devices under control of the application, and determining processing power that is available from the at least some of the registered operation processors based on the received device information and setting information.

4. The method of claim 3, wherein the device information further comprises hardware information about the registered electronic devices, and
the setting information further comprises at least one of time information set by a user of the registered electronic devices and time information set by the application installed and executed on the registered electronic devices.

5. The method of claim 1, wherein the step of requesting at least a portion of the registered operation processors to process the separated plurality of operations in a distributed manner comprises selecting the at least a portion of the registered operation processors to process the plurality of operations based on processing power that is required for each of the plurality of operations and processing power that is available from the registered operation processors, and requesting the selected at least a portion of the registered operation processors to process one of the plurality of operations.

6. The method of claim 1, further comprising the step of:
managing remuneration to be provided by the operation consumer in response to providing the processing results to the operation consumer, and managing a reward to provide to each of the registered operation processors providing the processing results to the operation consumer.

7. The method of claim 6, wherein the step of managing of the reward comprises determining the reward based upon an amount of processing power provided by the registered operation processors providing the processing results to the operation consumer and accumulatively managing the determined reward for the registered operation processors based upon the amount of processing power provided by the registered operation processors.

8. The method of claim 6, further comprising:
providing the remuneration to the operation consumer, from rewards that have been provided to the operation consumer, when the operation consumer was acting as one of the registered operation processors.

9. The method of claim 6, further comprising:
providing information about the reward to a service server associated with the cloud server,
wherein the service server is configured to perform either one of i) discount a service usage fee of a service for the registered operation processors based on the reward information and ii) to provide the service for free for the registered operation processors.

10. A non-transitory computer-readable storage medium storing instructions that, when executed by a processor, cause the processor to perform a cloud service method for operating a cloud server, the method comprising:
registering electronic devices as operation processors and operation consumers through communication with the registered electronic devices over a network;
separating, in response to an operation request from the an operation consumer for processing power, the requested operation into a plurality of operations;
requesting at least a portion of the registered operation processors to process the plurality of operations in a distributed manner in which more than one operation processors respond to the operation request;
receiving and collecting the distributed processing results of the requested operations from the at least a portion of the registered operation processors; and
providing the collected processing results to the operation consumer.

11. A cloud service system comprising:
a cloud server having at least one processor configured to execute computer-readable instructions,
wherein the at least one processor is configured to:
register electronic devices as operation processors and operation consumers through communication with the registered electronic devices over a network,
separate, in response to an operation request from the an operation consumer for processing power, the requested operation into a plurality of operations, request at least a portion of the registered operation processors to process the separated plurality of operations in a distributed manner in which more than one operation processor responds to the operation request,
receive and collect the distributed processing results of the requested operations from the at least a portion of the registered operation processors, and
provide the collected processing results to the operation consumer.

12. The cloud service system of claim 11, wherein the at least one processor is configured to manage processing power that is available from at least some of the registered operation processors.

13. The cloud service system of claim 12, wherein an application associated with the cloud service is installed and executed on at least some of the registered electronic devices, and
to manage processing power, the at least one processor is configured to receive device information and setting information provided from at least some of the registered electronic devices under control of the application, and to determine processing power that is available from the at least some of the registered operation processors based on the received device information and setting information.

14. The cloud service system of claim 13, wherein the device information further comprises hardware information about the registered electronic devices, and
the setting information further comprises at least one of time information set by a user of the registered electronic devices and time information set by the application installed and executed on the registered electronic devices.

15. The cloud service system of claim 11, wherein, to request at least a portion of the registered operation processors to process the separated plurality of operations in a distributed manner, the at least one processor is configured to select the at least a portion of the registered operation processors to process the plurality of operations based on processing power that is required for each of the plurality of operations and a processing power that is available from the registered operation processors, and to request the selected at least a portion of the registered operation processors to process one of the plurality of operations.

16. The cloud service system of claim 11, wherein the at least one processor is configured to manage remuneration to be provided by the operation consumer in response to providing the processing results to the operation consumer, and to manage a reward to provide to each of the registered operation processors providing the processing results to the operation consumer.

17. The cloud service system of claim 16, wherein, to manage the reward, the at least one processor is configured to determine the reward based upon an amount of processing power provided by the registered operation processors and to accumulatively manage the determined reward for the registered operation processors based upon the amount of processing power provided by the registered operation processors.

18. The cloud service system of claim 16, wherein the at least one processor is configured to provide the remuneration to the operation consumer, from rewards that have been provided to the operation consumer, when the operation consumer was acting as one of the registered operation processors.

19. The cloud service system of claim 16, wherein the at least one processor is configured to provide information about the reward to a service server associated with the cloud server, and
the service server is configured to perform either one of i) discount a service use fee of a service for the registered operation processors based on the information and ii) to provide the service for free for the registered operation processors.
